(19) United States
(12) Patent Application Publication
(10) Pub. No.: US 2001/0045398 A1
(43) Pub. Date: Nov. 29, 2001

(54) Process for immobilisation of particles in three dimensional structures

(76) Inventor: Pierre Messier, St-Sauveur (CA)

Correspondence Address: Timothy E. Nauman, Esq., Fay, Sharpe, Fagan,, Minnich & McKee, LLP, 1100 Superior Avenue, 7th Floor, Cleveland, OH, 44114-2518, US

(21) Appl. No.: 09/772,560

(22) Filed: Jan. 30, 2001

(30) Foreign Application Priority Data
Jan. 31, 2000 (CA) 2,297,513

(51) Int. Cl. B01D 37/00

(52) U.S. Cl. 210/764; 210/767

(57) ABSTRACT

A non woven porous material having particles (e.g. antimicrobial particles) immobilised in interstices of the three dimensional matrix structure thereof; as well as a process for the preparation thereof. The non woven porous material may be used an antimicrobial barrier (e.g. in a gas mask).

The present invention relates to a non woven porous material having particles (e.g. antimicrobial particles) immobilised in interstices of the three dimensional matrix structure thereof; as well as a process for the preparation thereof. The non woven porous material may be used an antimicrobial barrier (e.g. in a gas mask)

Porous structures having three dimensional matrixes containing particulate material are known (please see U.S. Pat. No. 5,952,092).

It would be advantageous to have a means for the preparation of non woven porous material having a desired activity (e.g. antimicrobial (e.g. anti bacterial, anti virus, etc.) activity) due to the immobilisation (i.e. entrapment) of particles (e.g. antimicrobial particles) in the three dimensional matrix structure thereof.

It is to be understood that for the purposes herein the expression “non woven porous material” is to be understood as referring not only to a material based on fibres and which may have a fibrous matrix structure but also to material which has a foam or sponge like character and which has a porous (i.e. open cell) matrix structure (weather man made or natural).

Accordingly, the present invention provides a process for the preparation of a non woven porous material having particles (e.g. antimicrobial particles) immobilised (i.e. entrapped) in interstices of the three dimensional matrix structure thereof, said process comprising contacting a non woven porous material having a three dimensional matrix structure with a suspension of particles (e.g. antimicrobial particles) in a dispersant fluid (e.g. a gas and/or liquid), said particles (e.g. antimicrobial particles) being of predetermined size and urging the dispersant fluid (e.g. a gas and/or a liquid) through the three dimensional matrix structure so as to entrain particles (e.g. antimicrobial particles) into the three dimensional matrix structure such that particles (e.g. antimicrobial particles) become (i.e. distributed) entrapped in the interstices of the three dimensional matrix structure of the non woven porous material and are held in place thereby.

The various conditions such as the amount of particles immobilised in the interstices of the non woven (e.g. fibrous) porous material, the type of dispersant fluid (i.e. gas or liquid), the type of non woven porous material etc. are of course to be chosen on the basis that they do not degrade or otherwise adversely affect the (desired) activity of the desired particles or the structure of the non woven porous material.

The size of the particles may be selected as a function of the size of the pore structure of the three dimensional (e.g. fibrous) matrix so as to facilitate entrapment of particles in the three dimensional matrix structure thereof. The amount of particles to be loaded as well as their size are also chosen such that a product is obtained for which an acceptable (low) pressure drop results from the physical entrapment or immobilisation of the particle in the interstices of the three dimensional matrix structure. The amount of particles to be included in the suspension is chosen in order to provide the desired or necessary loading of particles in the three dimensional matrix structure.

The particles may, for example as mentioned above be antimicrobial particles, i.e. particles which are able to kill or attenuate bacteria, viruses, etc.). They may be any type of (known) particles having antimicrobial properties (for example, see the iodinated disinfectant resin particles illustrated in U.S. Pat. No. 5,639,452—the entire contents of this patent is hereby incorporated herein by reference ). The particles may be of other type such as for example activated carbon, titanium oxide, etc.

The non woven porous material may be any (known) desired or necessary material; the material reflecting the ultimate use of the particle loaded non woven porous material or web (e.g. breathability in the context of a gas mask). The non woven porous may be a fibre based material having a fibrous matrix structure; it may be a sponge like material have an open cell matrix structure; it may be flexible or inflexible; etc. The non woven porous material may be of a type suitable for a high efficiency particulate air filter (i.e. an HEPA filter). A suitable non woven porous material may be obtained from Technol Aix en Provence Cedex 03 France (see Canadian patent no. 1,243,801); another suitable material may also be obtained from Wison Safety Pennsylvania USA (N95 and D95). The three dimensional structure of the non woven porous material should be configured in such a fashion as to provide a matrix structure able to entrap (i.e. physically) the desired particulate material. For example if the non woven porous material is based on fibres, the structural fibres of the non woven porous material should be present and and distributed in a such a fashion as to provide a fibrous matrix structure able to entrap the desired particulate material. The non woven porous material may have a micro porous structure. The interstices (i.e. openings) of the non woven porous material may have a size of 0.2 to 300 microns (e.g. a size of 5 to 100 microns (e.g. 5 to 25) microns). The particles to be entrapped may have a corresponding size in the range of from 0.1 to 350 microns (e.g. a size of from 10 to 100 (e.g. 5 to 25) microns (e.g. a dust like material)). Generally, in any event, the particles have a size appropriate to be entrapped by the three dimensional (e.g. web) matrix structure of the desired non woven porous material.

The non woven porous material may take the form of a sheet or mat; it may take the form of a type of fabric.

The non woven porous material may be loaded with from 0.1 to 90% (e.g. 5 to 90 percent) by weight of particles based on the weight of the non woven porous material. The amount of particles to be loaded may be selected keeping in mind the desire to achieve a loaded non woven porous material having the desired (level of) activity as well as for example a desired or necessary air permeability (e.g. the loaded non woven porous material may be one having an acceptable (low) pressure drop or breathability factor (e.g. acceptable in the context of being useful for filtering air in a face or gas mask)). In the context of a gas mask a non woven porous material loaded with appropriate particles may be used as a sort of bacterial or virial barrier. The loaded material may also be used in the context of a garment, a surgical drape, a tent making material, i.e. be used in the manufacture of garments, etc. which may act as bacterial or virial barriers.

The fluid may be a liquid dispersant which may be selected on the basis that it is able to wet the non woven porous material and does not significantly degrade either the woven porous material or the desired particles. The liquid dispersant may be a suitable alcohol (e.g. an alkanol of 1 to 6 carbon atoms); it may, for example, be a ketone of up to 5 carbon atoms; it may for example be an ether of up to 5 carbons atoms; water; etc. The fluid disperant may be a gas such as air, nitrogen, or other insert gas.

In drawings which illustrate example embodiments of the present invention:

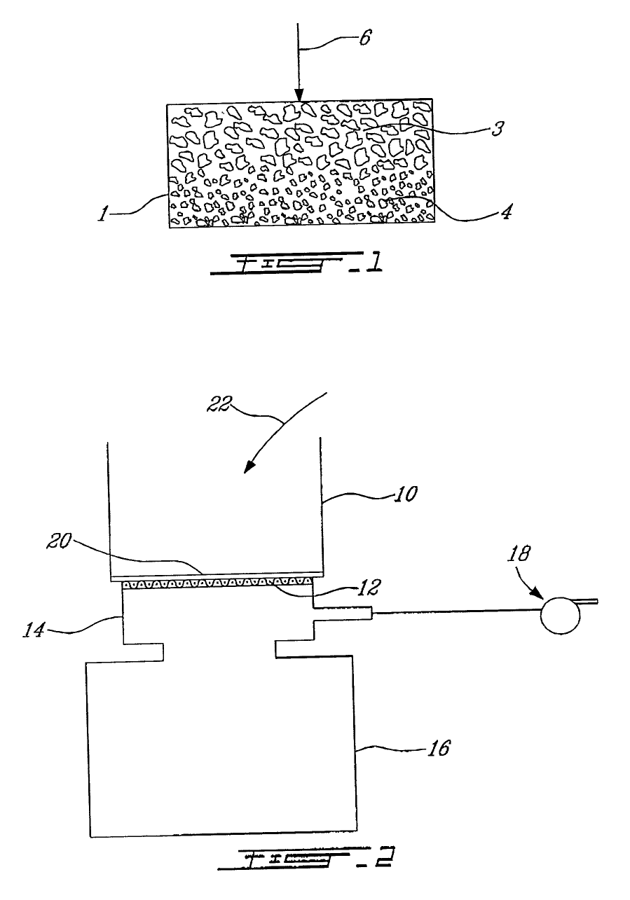

FIG. 1 is a schematic representation of a possible particle size distribution in a particle loaded non woven porous material;

FIG. 2 is a schematic illustration of an example system for the exploitation of the process of the present invention;

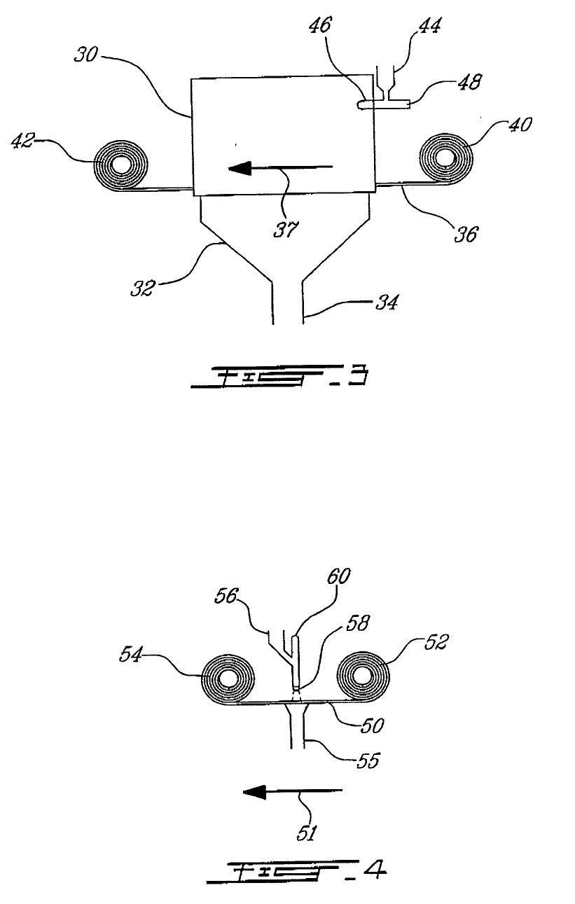

FIG. 3 is a schematc illustration of an example gas system for the exploitation of the process of the present invention; and

FIG. 4 is a schematc illustration of an alternate example gas system for the exploitation of the process of the present invention.

As discussed above the process of the present invention may be used to geometrically entrap particles into non-woven media or fabrics. This process allows a three dimensional dispersion of particles in the material. Referring to FIG. 1 this figure illustrates in schematic fashion (in a cross sectional view) a possible size distribution of particles in a non woven porous material 1; FIG. 1 displays that the larger particles 3 are entrapped or held to the upper transversal portion of the non woven porous material 1, while smaller finer particles 4 are entrapped or held to the lower portion; this type of distribution may be obtained using a system as set forth in FIG. 2 the suspension flow being in the direction of the arrow 6.

The embedding or entrapment process is initiated by suspending the desired amount of particles of predetermined size in a specified liquid; thereafter the process involves urging this suspension through a desired non woven media or fabric.

FIG. 2 illustrates in schematic fashion an example setup which may be used to produce particle loaded materials in accordance herewith. The example setup has the following

components; a suspension tank 10, holding mesh 12, differential pressure chamber 14, collection tank 16 and a vacuum system 18.

The process may be carried out as follows: the non woven porous material 20 to be particle loaded is placed on the holding mesh of the apparatus and the vacuum system is activated so as to subject the non woven porous material to the influence of a vacuum on the downstream side thereof. It is to be noted at this point that alternate means may also be used to urge the suspension into the non woven porous material, such as for example a piston like means which pushes down from above against the suspension (e.g. a gas (e.g. air) or a solid piston). In any event, the pre-prepared particle-liquid suspension is then poured into the suspension tank 10 in the direction of the arrow 22, on top of the non woven porous material 20, and is urged (due the influence of the vacuum) through the non woven porous material 20 by the negative pressure in the differential pressure chamber 14 caused by the vacuum system 18. As a result particles in the suspension are entrapped or imbedded (i.e. physically) into their geometric counter parts in the non woven porous material 20, while the remainder of the smallest particles (if any) and the dispersant liquid (e.g. ethanol) flows through the holding mesh 12 and into the collection tank 16. Thereafter the particle loaded non woven porous material is removed from the system (and if necessary allowed to dry).

Several experiments were done to produce some example particle loaded non woven porous materials. A detailed example follows explaining the steps taken to produce a sample. The following equipment was used to produce sample A.

complete apparatus as shown in FIG. 2

a Technol (non woven) filtering medium, cut to a 47 mmn diameter

0.1 grams of Triosyn T-50, 5 μm particles, (an iodinated biocidal resin containing 50% by weight iodine—obtainable from Hydro Biotech Inc. Mirabel Quebec, Canada

20 milliliters of ethanol (85% ethanol)

50-milliliter beaker and stirring rod

### Example 1

The stationary apparatus was attached to the vacuum system, and the cut technol filter was placed over the mesh holder. 0.1 grams of Triosyn particles and the 20 milliliters of ethanol were poured into the 50 milliliters beaker. The two products were stirred vigorously; causing the Triosyn particles to become suspended in the liquid (ethanol). The suspension was then poured into the suspension tank where it was urged through the technol non-woven medium. The Triosyn particles remained geometrically adhered to the filtering media and the ethanol flowed through the medium and mesh holder and into the collection tank. The technol medium was then removed from the apparatus and allowed to dry for 60 minutes at ambient conditions.

Sample A was then tested for air resistance and biocide efficiency; the biocide protocols used were as described in the above mentioned U.S. Pat. No. 5,639,452 the entire contents of which are incorporated herein by reference. The results of these tests are presented in table 1. Another example of the Triosynated filtering media (sample B) was made following the above procedure but with 0.2 grams of Triosyn particles instead of 0.1 grams; this also was tested for air resistance and biocide efficiency. Several other biocide and air resistance tests were performed and are presented in table 1. The biocide tests display the number of viruses, which manage to survive the different filtering medias.

### MS2 Phage Challenge of Different Air Filtration Materials

TABLE 1

| | | | | Pressure |
|---|---|---|---|---|
| | Positive | Residual | Reduction | drop |
| Tested material | control | virus | percentage | (mmH2O) |
| Technol filtering media | 2850000 | 295000 | 88.333 | 6.7 |
| Blank (media alone) | | | | |
| sample A; | 2010000 | 6100 | 99.7 | 18.0 |
| 0.1 gram Triosynated | | | | |
| filtering medium | | | | |
| sample B | 23000000 | 75 | 99.99997 | 49.0 |
| 0.2 gram Triosynated | | | | |
| filtering media | | | | |
| 3M HEPA paper | 2000000 | 167 | 99.992 | 38.7 |
| obtained from 3M | | | | |
| (3M) | | | | |
| two sheets of sample A | 6700000 | 53 | 99.9992 | 26.7 |
| filtering media were | | | | |
| used with the media | | | | |
| being placed back to | | | | |
| back during the tests | | | | |

MS2 Coliphage

The challenge organism used for the tests is MS2 (ATCC 15597-B1). MS2 is an approximately 26 nm icosahedral bacteriophage that infects Escherichia coli (ATCC 15597). It is an accepted surrogate for viral BW agents, including Ebola and Venezuelan Equine Encephalitis. MS2 is prepared according to Dugway Proving Ground SOP.

Referring to FIG. 3, this figure illustrates in schematic fashion an example system wherein the dispersant fluid is a gas. The system has an atomizing chamber 30 and a vacuum chamber 32; the vacuum chamber 30 is connected to a vacuum source (not shown) at the funnel opening 34. The filter media 36 divides or separates the atomizing chamber 30 from the vacuum chamber 38; i.e. the filter media 36 defines or forms at least a portion of the floor of the atomizing chamber 30 and at least a portion of the ceiling of the vacuum chamber 32. The filter media 36 is disposed and configured so as to pass through (in the direction of the arrow 37) from one side of the chambers (i.e. unrolling from a roll 40 of untreated filter media) to the opposite side of the chambers (i.e. rolling up into a roll 42 of treated filter media); this type of filter media disposition and travel is known (such a filter means is known for example in the automatic coffee machine art). The system has a powder atomizing nozzle assembly which includes a powder meter 44, a powder atomizing nozzle means 46 and an input means 48 for compressed air.

The example gas process as associated with the example system as shown in FIG. 3 uses a vacuum source (not shown) to pull the Trio syn particles through the filtering media 36 from the atomizing chamber 30. The Triosyn powder is suspended in the atomizing chamber 30 using the Powder atomizing nozzle assembly. The powder meter 44 on the powder atomizing nozzle assembly measures a specified amount of Triosyn powder. The compressed gas from the input means 48 urges the powder into the atomizing chamber 30 creating a mist of Triosyn particles and gas. Immediately following the suspension on the Trisoyn, the vacuum supply is activated, hence pulling all the Triosyn particles into the untreated media, using the gas as the particle carrier. The now Triosynated media is advanced in the direction of the arrow 37 and the process starts over.

Referring to FIG. 4, this figure illustrates in schematic fashion an alternate example system wherein the dispersant fluid is a gas. The system example system as shown in FIG. 4 uses a spray/vacuum combination to embed Triosyn particles into the media. This system has a filter media 50 which is also disposed and configured so as to pass through (in the direction of the arrow 51) from one side of the device (i.e. unrolling from a roll 52 of untreated filter media) to the opposite side of the device (i.e. rolling up into a roll 54 of treated filter media). The device has a means for applying vacuum to the opening means 55 on one side of the filter media 50. A spray powder atomizing nozzle assembly or combination is disposed on the opposite side of the filter media and includes a powder meter 56, a powder spray jet (i.e. atomizing) nozzle means 58 and an input means 60 for compressed air.

The alternate example gas process as associated with the example system as shown in FIG. 4 uses the spray/vacuum combination to embed Triosyn particles into the media. As the filter media 50 passes the spray system, a gas (e.g. compressed air) containing Triosyn particles are sprayed onto the untreated media, concurrently a vacuum pull is present under the media to aid in the three dimensional dispersion of the particles.

1. A process for the preparation of a non woven porous material having particles immobilised in interstices of the three dimensional matrix structure thereof, said process comprising contacting a non woven porous material having a three dimensional matrix structure with a suspension of particles in a dispersant liquid, said particles being of predetermined size, and urging the dispersant liquid through the three dimensional matrix structure so as to entrain particles into the three dimensional matrix structure such that particles become entrapped in the interstices of the three dimensional matrix structure of the non woven porous material and are held in place thereby.

2. A process as defined in claim 1 wherein said particles comprise antimicrobial particles.

3. A process as defined in claim 1 wherein said particles comprise iodinated disinfectant resin particles.

4. A process for the preparation of a non woven porous material having particles immobilised in interstices of the three dimensional matrix structure thereof, said process comprising contacting a non woven porous material having a three dimensional matrix structure with a suspension of particles in a dispersant fluid, said particles being of predetermined size, and urging the dispersant fluid through the three dimensional matrix structure so as to entrain particles into the three dimensional matrix structure such that particles become entrapped in the interstices of the three dimensional matrix structure of the non woven porous material and are held in place thereby.

5. A process as defined in claim 4 wherein said particles comprise antimicrobial particles.

6. A process as defined in claim 4 wherein said particles comprise iodinated disinfectant resin particles.
